(19) United States
(12) Patent Application Publication
(10) Pub. No.: US 2002/0007353 A1
(43) Pub. Date: Jan. 17, 2002

(54) Pricing and costing system, method and computer program product

(76) Inventor: Dennis Kornacki, Norton, OH (US)

Correspondence Address: OLDHAM & OLDHAM CO, TWIN OAKS ESTATE, 1225 W MARKET STREET, AKRON, OH, 44313, US

(21) Appl. No.: 09/809,563

(22) Filed: Mar. 15, 2001

Related U.S. Application Data
(60) Provisional application No. 60/189,547, filed on Mar. 15, 2000.
(60) Provisional application No. 60/192,676, filed on Mar. 28, 2000.

(51) Int. Cl. G06F 17/00

(52) U.S. Cl. 705/400

(57) ABSTRACT

The present invention provides a system, method and computer program product for determining the amount of space occupied by shipments in a carrier unit and prices and costs associated with transporting such shipments. The present invention provides a means for optimizing space utilization in the carrier unit and computing charges based upon the amount of space occupied by a particular shipment. The present invention provides a means for determining charges for transporting a particular shipment based upon the distance that the shipment is to be transported and various physical properties of the shipment such as the shipment dimensions, weight or density.

### TECHNICAL FIELD

The present invention relates to a pricing and costing system, method and computer program product which is particularly useful in the shipping industry. The present invention comprises a system, method and/or computer program product designed to optimize usage of space in vehicles or units used in shipping such as trucks, trains, ships or airplanes. In addition, the present system, method, and computer program product may also be used to determine prices and costs associated with hauling a particular shipment. The prices and costs may be based on variable factors with respect to the shipment. The present invention may also be used to optimize the space used in warehouses.

### BACKGROUND

Virtually all businesses and individuals require products or goods to be shipped from one place to another at some time. The products shipped are usually packaged in boxes or cartons of some type. Products may also be unitized on pallets or slipsheets or in crates. The products and packaging may be of various sizes, regular or irregular. In addition, in many cases, the products are perishable, fragile or dangerous. In these cases, the carrier must be careful about the other products which may be shipped with these types of goods. Further, carriers are typically unable to stack other packages on top of fragile or unusually shaped packages. If these packages do not take up the entire height of the shipping space, then space above these packages is wasted for that particular trip.

Presently, charges for the shipping of freight are calculated based upon a “class” of goods. Classes are determined by several characteristics or properties of the goods being shipped, including the density of the goods e.g. the mass multiplied by the dimensions of the package, the value, the propensity for damage to other freight, potential liability with respect to the goods. Historically, classes were determined based on average densities for certain types of goods. For instance, most children's toys, such as trucks or cars, were formerly made of metal. Now these toys are made of plastic which is much lighter. Thus, shipments of children's toys may be being shipped at a different class or charge than appropriate, because the characteristics have changed and standards have not changed. Furthermore, shippers may estimate the size, density or class of the packages they are requesting to be shipped. Any inaccuracies in these estimates may not be noticed until a carrier has already begun loading the shipping unit. The carrier at this time may or may not realize that the packages for this particular shipper may take up more or less space than estimated. This will cause the carrier to either have to leave out some freight or to travel with valuable space unused.

In addition to the problem of estimating the size or class of the freight, is the issue of how to figure out the costs of carrying a particular shipment from point A to point B or the price to the shipper for having the freight shipped from point A to point B. It is apparent that these numbers may be different. The carrier, of course, wants to make a profit for transporting the products for the shipper, while the shipper wants to ship his goods at the lowest possible rate while still retaining quality. The cost of shipping necessarily depends on the type of carrier unit (truck, plane, boat etc.), the type, size, weight and other characteristics of the product being shipped, and the distance that the product will be shipped. In order to determine the profit to the carrier, the carrier must add on a factor or a dollar amount to the cost of shipping when it quotes a price to the shipper. This amount namely, profit, should be included in the rate.

Presently, in the prior art, the estimations of the prices and costs to the shippers and carriers are inaccurate. This is due to several circumstances. One is that shippers are not providing carriers with accurate information about the dimensions, weight, or mass of the products to be shipped. In addition, when shippers provide carriers with class information, this information may be incorrect, either due to ignorance of the shipper or the use of an outdated schedule of classes. Either way, this is detrimental to both the shipper and the carrier. If the shipper's statements regarding the size or the class of the packages are inaccurate in that they are too low, the carrier may not have room to take the entire shipment or it may have to split the shipment in some manner to accommodate, which may affect other shipments or cause some delay in the balance. This may cause the carrier to lose business from the shipper whose packages were unloaded or will add costs to the carrier due to the use of additional equipment and labor. In the current practice, this may cause additional charges to be passed onto the shipper because its shipment took up more room than was calculated for in the original price estimate. But, these costs may be missed entirely by the carrier, simply because of the practice of General Classification by properties of the goods, which are effectively only estimates of these properties, and which cause inherent inaccuracies in the charged rate. If the shipper's statements are inaccurate on the high side, the carrier will be transporting with valuable unused space, or at charges less than appropriate for the amount being shipped. In this situation, the shipper might be paying for space that it is not utilizing, while the carrier could have contracted with another shipper to use the left over space. Further, carriers have to account for various facets in the shipping process when they determine costs and prices. Carriers incur costs as they transport goods such as vehicle maintenance, gasoline, labor and other administrative costs. These costs can increase as packages are transported farther distances. In addition, carriers may provide discounts to shippers for certain actions that increase the carrier's convenience. For instance, if one shipper takes up all the space in a truck for a trip to a particular destination and then also takes up all the space in a truck for the trip back to the truck's origin, the carrier might give the shipper a discount because there is no unused space or travel time on the carrier's part. Such arrangements are beneficial both to the carrier and the shipper.

In the present state of the art, shippers and carriers use a type of honor system to determine dimensions, weight, density, or class of a shipment. These situations cause inaccuracies in the cost estimation by the carrier and the price estimation quoted to the shipper by the carrier. Such inaccuracies in the United States amount to millions of dollars of lost revenues to carriers as well as shippers.

### SUMMARY OF THE INVENTION

In light of the limitations in the present art, the present invention comprises a system, method and computer program product for determining pricing and costing associated with shipping or storing goods and packages. The present also comprises a system method and computer program product for determining the amount of space in a carrier unit occupied by a shipment and the optimal orientation of the shipment in the carrier unit.

The present invention includes a computerized method for calculating charges for transporting a shipment of freight. The shipment may comprise one or more packages, and the method includes the steps of gathering physical property data about a carrier unit such as the carrier unit dimensions (length, width, height) a weight limit of said carrier unit and determining a total available capacity in said carrier unit which includes the weight limit, volume, total length and density capacity of the carrier unit. The present invention also includes features to gather a distance a shipment is to be transported and physical property data about the shipment including but not limited to dimensions (length, width, height) of one package in a shipment, volume of one package in the shipment, weight of one package in the shipment, mass of one package in the shipment, dimensions of all the packages in the shipment, total weight of all the packages in the shipment, volume of the shipment, mass of the shipment, number of packages in the shipment, total density of said shipment, and the class of said shipment. The class of the shipment can be used to determine a density range for the shipment.

Also involved in the present invention is determining an amount of the total available capacity of the unit to be occupied by a shipment when placed in the carrier unit. The amount of total available capacity to be occupied by a shipment includes the total weight of the shipment and the total volume that will be occupied by the shipment. In addition the present system, method and computer program product will determine the remaining capacity available in the carrier unit after a shipment is loaded into said carrier unit.

Another aspect of the present invention is an application to determine the optimal orientation of packages and shipments in the carrier unit. The optimal orientation is the most efficient space utilization in the carrier unit. The present invention can determine the optimal orientation of shipments relative to the size and shape of the carrier unit as well as other shipments and packages which are to be placed in the carrier unit. The present invention will rearrange orientation of shipments as needed to accommodate subsequently added shipments and maintain the optimal space utilization.

Another feature of the present invention involves determining a rate to be charged for said first shipment based upon the results of the area space calculation described above and the distance that the shipment is going. The rate can be one that is predetermined by the present invention or agreed upon by carriers or shippers for transporting a shipment.

Total charges are calculated based on various outcomes of the above described process including the amount of space the shipment takes up in the carrier unit, the weight of the shipment, the length of the shipment, and the distance, for examples.

The functions and features described herein can be accomplished by a data processing system, a computer program product or a method. A system for implementing the current invention will include a computing device and display and means for entering information and storing and recalling all of the computed values in the process.

### BRIEF DESCRIPTION OF THE DRAWINGS

FIG. 1 is a schematic diagram showing a carrier unit and shipments to be loaded on that unit.

FIG. 2 is a flow diagram overview of the area space calculation feature of the system, method and computer program product of the present invention.

FIG. 3 is a flow diagram illustrating the process for calculation of unit capacity in the present invention.

FIG. 4 is a flow diagram illustrating the process for calculating the space or weight utilized by a particular package or shipment and the remaining capacity in a unit in the present invention.

FIG. 5 is an illustration of an example shipment.

FIG. 6 is a flow diagram illustrating operations performed by the area space calculator in the present invention.

FIG. 7 is a flow diagram overview of the pricing and costing system, method and computer program product of the present invention.

FIG. 8 is a flow diagram illustrating the calculation of cube and density in the system, method and computer program product of the present invention.

FIG. 9 is a flow diagram illustrating a calculation of the optimum unit width utilization in the present invention.

FIG. 10 is a flow diagram illustrating an alternative pricing and costing system, method and computer program product in the present invention.

### DETAILED DESCRIPTION OF THE INVENTION

The present invention is fully described hereinafter with reference to the drawings, in which preferred embodiments of the invention are shown. The invention may also be embodied in many different forms and should not be construed as limited to only the disclosed embodiments. The provided embodiments are included so the disclosure will be thorough, complete and will fully convey the scope of the invention to persons of ordinary skill in the art.

A person of ordinary skill in the art would appreciate that the present invention may be embodied as a method, data processing system, or computer program product. As such, the present invention may take the form of an embodiment comprised entirely of hardware; an embodiment comprised entirely of software or an embodiment combining software and hardware aspects. In addition, the present invention may take the form of a computer program product on a computer-readable storage medium having computer-readable program code means embodied in the medium. Any suitable computer readable medium may be utilized including hard disks, CD-ROMs, optical storage devices, or magnetic storage devices.

The present invention is described with reference to flowcharts and/or diagrams that illustrate methods, apparatus or systems and computer program product. It should be understood that each block of the various flowcharts, and combinations of blocks in the flowcharts, can be implemented by computer program instructions. Such computer program instructions can be loaded onto a general-purpose computer, special purpose computer, or other programmable data processing device to produce a machine, such that the instructions that execute on the computer or other programmable data processing apparatus create means for implementing the functions specified in the flowcharts. The computer program instructions can also be stored in a computer-readable memory that directs a computer or other programmable data processing device to function in a particular manner, such that the instructions stored in the computer-readable memory produce an article of manufacture including instruction means which implement the function specified in the flowcharts or diagrams. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowcharts or diagrams.

It will be understood that blocks of the flowcharts support combinations of means for performing the specified functions, combinations of steps for performing the specified functions and program instruction means for performing the specified functions. It is also to be understood that each block of the flowcharts or diagrams, and combinations of blocks in the flowcharts or diagrams, can be implemented by special purpose hardware-based computer systems which perform the specified functions or steps, or combinations of special purpose hardware and computer instructions.

The present invention could be written in a number of computer languages including, but not limited to, C++, Basic, Visual Basic, Fortran, Cobol, Smalltalk, Java, HTML, XML, and other conventional programming languages. It is to be understood that various computers and/or processors may be used to carry out the present invention without being limited to those described herein. The computers are IBM, IBM-compatible, or other personal computer, preferably utilizing a DOS, Windows 3.1, Windows 95, Windows NT, Unix, Linux, MacOS, PalmOS, OS/2, or any other HTML capable operating system. However, it should be understood that the present invention could be implemented using other computers and/or processors, including, but not limited to, mainframe computers and mini-computers.

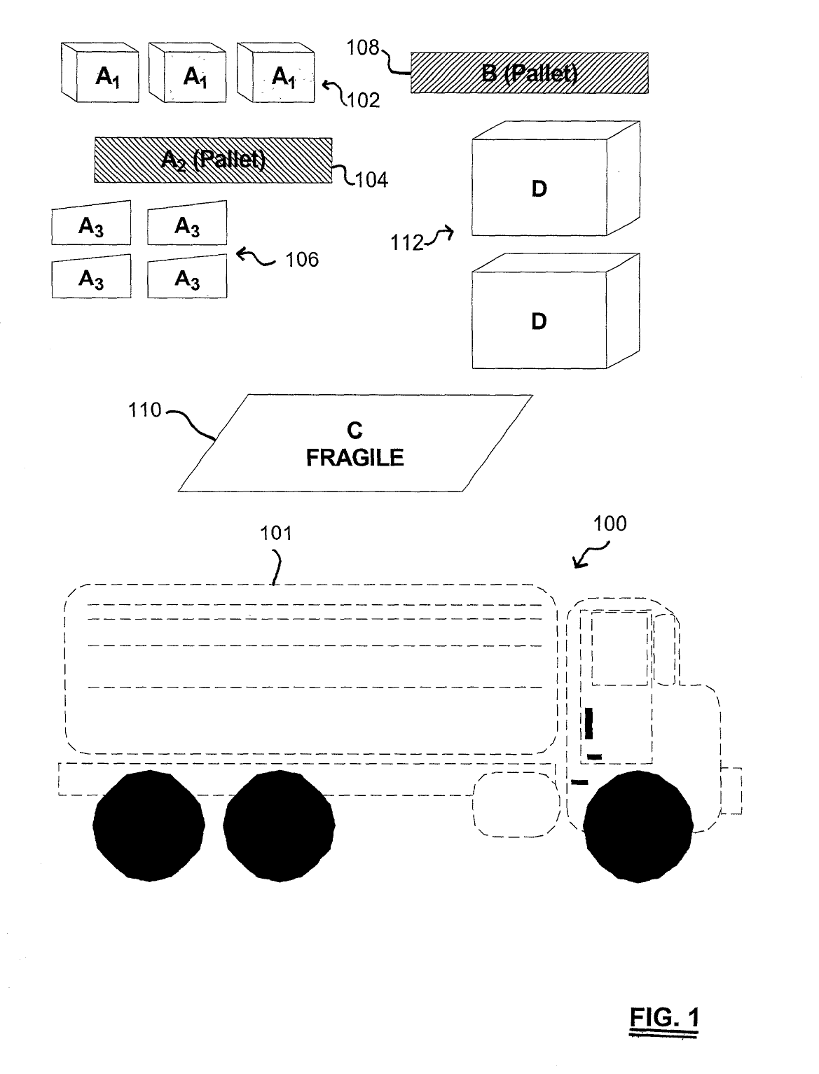

Turning now to FIG. 1, a schematic example of packages to be loaded on a truck is illustrated. It should be understood that the applications described herein could be used for any type of shipping unit or even a storage unit and that the truck illustrated herein is by way of example only. In this example, which forms the basis for describing some of the elements of the present invention, four different shippers A, B, C, and D have packages to ship via a carrier, in this example a truck 100. A shipper in the present invention is a party who requests that goods be transported from a point of origin to a destination, in other words from point P to point Q. For instance, a retail store chain may request that various packages be shipped from a warehouse to some of the retailer's stores. It is contemplated that the present invention will have applications in the shipping of a wide variety of package types.

In FIG. 1, Shipper A is shipping three package types, A1 102, cube shaped boxes, A2 104, a group of packages shipped on a pallet, and A3 106, a group of irregularly shaped packages. Packages on a pallet are arranged on a type of “shelf” or “platform” which is used by mechanical equipment such as a forklift to facilitate ease of handling. Pallets can be stacked, depending on the type of pallets and/or the type of packages arranged on the pallet. Shipper B is shipping a group of packages on a pallet 108 as well. Shipper C is shipping a trapezoidal shaped package having fragile contents 110 and Shipper D is shipping large cube shaped boxes.

Each of the different “shipments”, A1 102, A2 104, A3 106, B 108, C 110 and D 112, presents an issue with respect to area and space in truck 100 as well as the cost to the carrier (truck 100) and price to each of the various shippers. Each of the shipments will take up a certain amount of space in truck 100. The truck necessarily must travel a certain distance to move the packages from point P to point Q. Thus, there is an inherent cost to the carrier for such a transport. Carriers must cover the cost of gasoline, maintenance to the vehicles, driver's salary, other administrative costs and so on. This, in turn, results in the “price” which is passed on to the shippers who request that packages be transported.

The present invention provides a system, method and/or computer program product for calculating these costs and prices. In addition, the present invention provides a means for maximizing the carriers usage of space when loading packages. Space usage may be related to the costing and pricing system.

It should be understood that the dimensions, mass, weight and any other physical attributes of packages or pallets can be measured in various units of measurement, including standard U.S. units (e.g. inches, feet, pounds) or metric units (centimeters, meters, kilograms). Contained in the present system, method and computer program product will be the various conversion factors necessary to convert from standard to metric units as well as to convert from one standard unit to another or one metric unit to another. For example, a user of the present invention can enter a mass of a package, such as 50 kilograms. The present invention will have the conversion factor 1 kg=2.2046225 lb stored in the program. The user can select to or the program can automatically perform the operation to convert 50 kg to 110.23112 lbs. Further, if a user has a package that is 3 feet high, the program can automatically convert this to inches using the conversion factor 1 ft=12 in. The result of the conversion, 36 in, can be displayed or used in calculations automatically or at the user's request. As another example, the user can choose to convert the standard measure 36 in to centimeters. The conversion factor 1 in=2.5399956 cm will automatically be entered into an equation to result 91.438416 cm. Finally, this number of centimeters can be converted to meters using the factor of 1 m=100 cm, resulting in 0.9143841 m. The necessary metric and standard conversion factors will be included, so that a user does not have to go through the steps of looking up the conversion and performing the calculations. The program will allow a user to easily convert units of measurements.

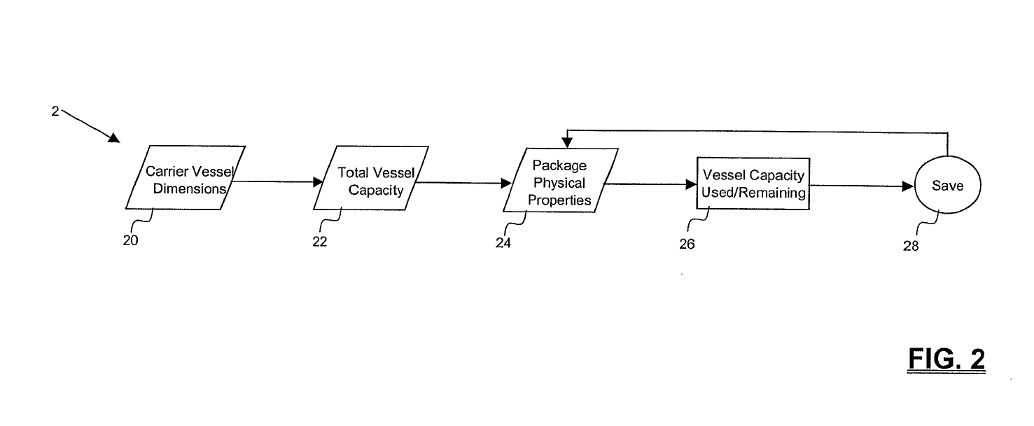

Turning now to FIG. 2, is presented an overview of the area space calculator of the present invention, generally designated 2. Generally, the area space calculator takes in information about the packages to be shipped on a particular carrier unit and calculates the amount of space or area each package will occupy and the space remaining in the unit. As shown in the overview 2, the user of the system inputs the carrier unit dimensions 20. The unit may be a truck, van, trailer, train car, airplane or even a warehouse. From this dimensional information, the system calculates the total capacity of the unit 22. The total capacity includes the total area available in the unit as well as the maximum weight that the unit can accommodate. The maximum weight may depend on the type of vehicle, for instance the weight that the vehicle's suspension system can handle. In addition, often highways and other roadways will have a weight limit that vehicles travelling over these roadways cannot exceed. The system of the present invention can be programmed to account for the limitations of specific vehicles or general classes of vehicles when making the capacity calculations. The maximum weight can also depend on the area available in the unit. The next step in the overall process 2, is to enter the physical properties of the packages 24 to be loaded. In a computer program product or data processing system in accordance with the present invention, the user may select an option such as “add packages” to obtain a screen or form to enter this information. This information includes package dimensions, package weight, and number of packages. This information may also include the shape of the package and whether or not other packages could be stacked on top of a particular package. Based on this information, the system of the present invention will calculate the amount of the unit's capacity that has been used and is remaining 26. If there is room remaining in the unit, the user saves 28 this information and returns to step 24 to add more packages.

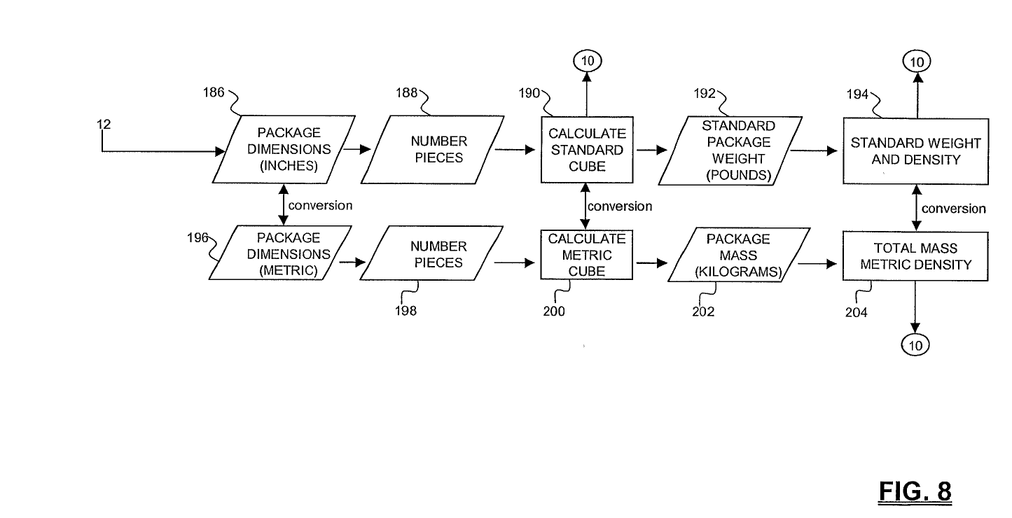

To illustrate this process briefly, the unit and some packages illustrated in FIG. 1 will be used. For instance, if the trailer portion 101 of the truck 100 is 16 feet long, 12 feet high, and 12 feet wide, the total area or “cube” available in the trailer is 2304 cubic feet. The term “cube” will be used often in this disclosure. The “cube” is simply the area/volume of the unit, package or a total shipment. The cube is calculated by multiplying the unit, package or shipment dimensions: length times width times height. For multiple packages of the same size, the cubes can be added together to determine the total cube for the entire shipment. Each of these dimensions is measured using a known unit of length, such as meters or inches. Thus, the result of this calculation is in units of length cubed, for instance, cubic feet, cubic centimeters, or any other unit of measurement. The present invention can provide a means for calculating cube which is generally designated 12 and is described in relation to FIG. 8.

Returning to the example, the total cube capacity of the unit is 2304 cubic feet. The program will also calculate the weight limit for this particular truck 100 based on roadway weight limits and the vehicle characteristics which will be programmed in, either by the vendor of the system or the user. In this example, the weight limit of truck 100 is 3000 lbs. When beginning the area/space calculation, the user inputs the information about the first set of packages. In this case, the first set will be packages A₁ 102. In this example, each A₁ 102 package is 4 feet long, 3 feet high and 3.5 feet wide and weighs 50 lbs. The cube occupied by one package would be 42 ft³. The user would also input the fact that these packages can be stacked on top of one another, or have other packages stacked on top of them. In a preferred embodiment of the present invention, the program or system assumes that the packages can be stacked unless otherwise specified. The total cube occupied by the three packages would be 126 ft³ (42 ft³+42 ft³+42 ft³). The total weight of the shipment is 150 lbs. The area/space calculator will also calculate the remaining space in the unit which is 2178 ft³ (2304 ft³−126 ft³) and 2850 lbs. The user will save 28 this information and return to the form or screen for entering the properties for additional packages 24.

At this point, the user will enter the information for a second shipment of packages A₃ 106. These packages are irregularly shaped. The dimensions for each package A₃ 106 are 3 feet long, 5 feet high (at the tallest point) and 2.5 feet wide and weigh 40 lbs. Because of the irregular shape of packages A₃ 106, in this example, nothing can be stacked on top of any of these packages. The program will calculate that the cube of one of these packages is 37.5 ft³. Based on these dimensions, the total cube occupied by these packages A₃ 106 is 150 ft³. However, this number is deceptive, because due to the irregular shape of packages A₃ 106, they may take up an entire section of at least the height of trailer 101. If this is the case, the height dimension of packages A₃ 106 must be adjusted to be the height of trailer 101 which is 12 ft. Although this example is used for the purpose of illustrating this feature of the present invention, the present industry standard is to use 84 inches for the adjusted height. However, it is contemplated by the present invention that any maximum height could be used. If no other packages are to be loaded, including A₁ 102 discussed above, the new cube of packages A₃ 106 becomes 360 ft³ [(3 ft×2.5 ft×12 ft)×4 packages]. Because the price to a shipper is in proportion to the amount of space taken up by the packages, the Shipper of packages A₃ 106 will be paying more than the actual size of the packages, because of their irregular shape.

However, if some or all of packages A₃ 106 can be stacked on top of the already entered A₁ 102 packages, this would be a more efficient utilization of space. The total length of all three A₁ 102 packages is 12 feet. The total length of all four A₃ 106 packages 106 is 12 feet. If the A₁ packages were placed in a single stack in a row they would occupy 3 feet of the height of the trailer for 12 feet. If the A₃ packages were stacked on top of the A₁ packages the total height would be 8 feet, thus minimizing the total cube of the A₃ packages. The cube would now be 270 ft³ [(3 ft×2.5 ft×9 ft)×4 packages]. The height of the packages is reduced from 12 ft to 9 ft because 3 ft of the total trailer height is occupied by packages A₁ 102.

The system then calculates the total space/weight occupied by the packages as currently entered 396 ft³ and 310 lbs and calculates the space and weight left available which is 1908 ft³ and 2690 lbs. The area/space calculator will continue to calculate and rearrange the orientation of packages in the trailer until all of the space and/or weight limit is utilized, or the user runs out of packages to add to the trailer.

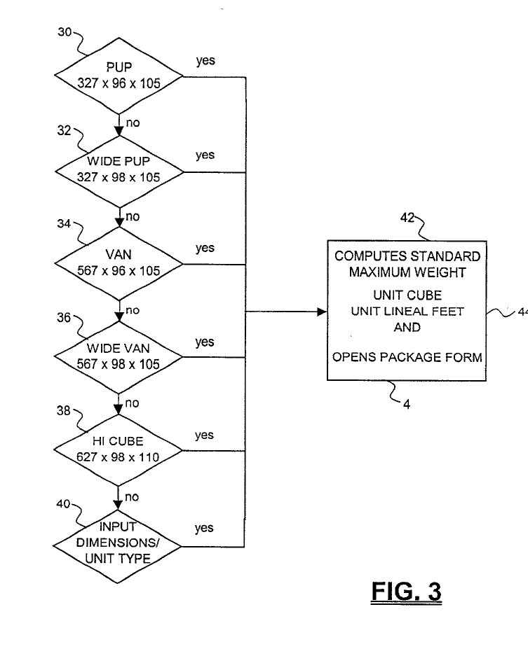

FIGS. 3-6 illustrate the area/space calculator of the present invention in more detail. Starting with FIG. 3, an example of the process for calculating the total capacity of the unit is illustrated. It should be understood that the system, method or computer program product of the present invention may have some information programmed in the system so that the information does not have to be entered by the user. However, certain information may optionally be internally programmed into the system or entered by the user, for instance in response to a prompt.

As shown in FIG. 3, standard types of carrier units and their dimensions can be programmed or entered into the system. The dimensions as shown in the flow chart are in the order of length, width, height. A PUP unit 30 is a trailer that is generally 28 ft long and may be hauled in combination with as many as two others hauled in combination as a single unit. The PUP unit 30 will have dimensions of 327×96×105. A WIDE PUP unit 32 is similar to PUP except that it is wider to allow full size pallets to be loaded in the width of trailer. This is alternatively called high cube pup in the industry. The WIDE PUP unit 32 will have dimensions of 327 in×98 in×105 in. A VAN unit 34 is a full length trailer which is usually 45 to 48 feet long and is hauled as a single unit. The VAN unit 34 will have dimensions of 567 in×96 in×105 in. A WIDE VAN unit 36 is a full length trailer usually 45 to 48 feet long that is wider to allow full size pallets loaded side by side in width of trailer. The WIDE VAN unit 36 will have dimensions of 567 in×98 in×105 in. A HI-CUBE type unit 38 is a full length trailer usually longer than 48 feet and both wider and higher with more loading space than the other types of units mentioned. The HI-CUBE unit 38 will have dimensions of 627 in×98 in×10 in. If none of these options is applicable to the particular unit, the user may input the dimensions and the type 40 of the particular unit. From this information, the area/space calculator system will compute the maximum weight or mass 42 that can be loaded onto the unit. This calculation will be based on factors such as the type of unit and the total area available. The system will also calculate the cube or area available and the total length available in the unit 44. The completion of this portion of the calculation will either prompt the user to open or will automatically open the package form 4 so that the user can enter information about packages into the system.

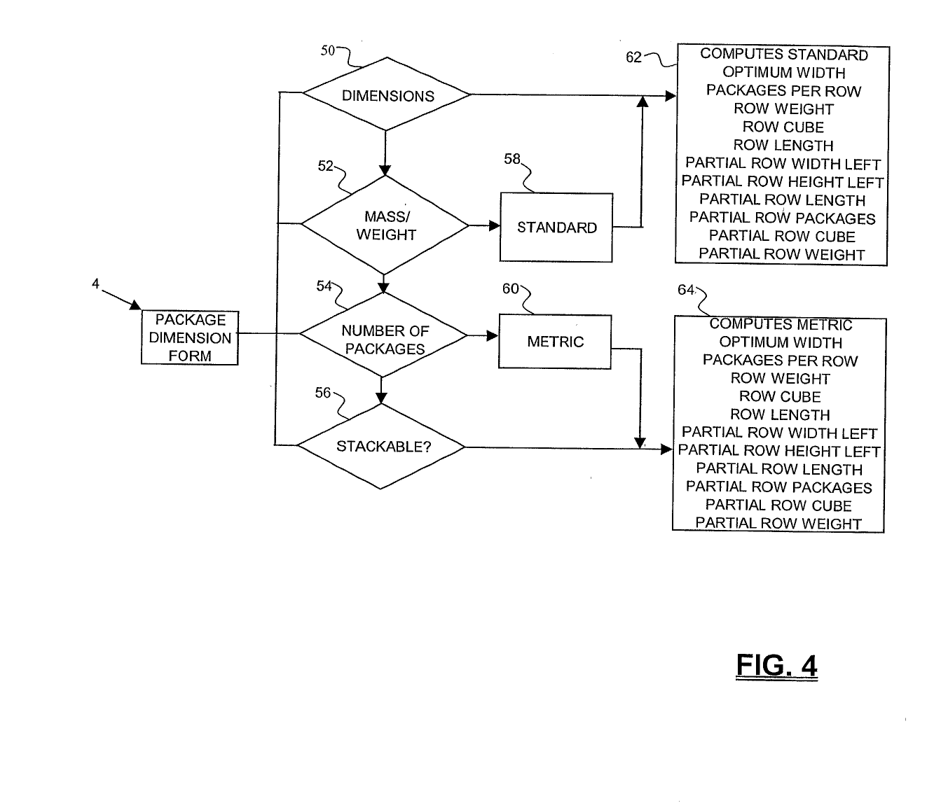

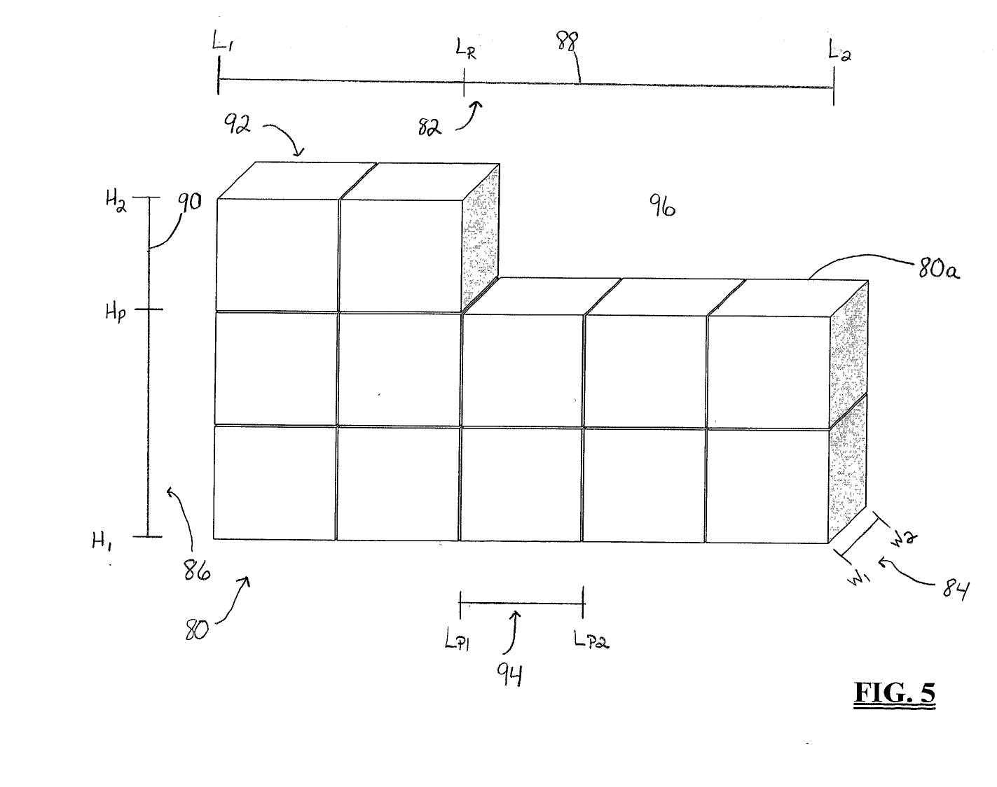

Turning now to FIG. 4, the operation of the package data entry portion 4 of the present invention is illustrated. This figure also shows that package data can be utilized in standard 58 or metric 60 units. As illustrated, the data entered can be converted from standard to metric or metric to standard and either or both of these units of measurement can be used in the final outcome of the calculations, illustrated as 62 and 64. In the package data entry form 4, the user will be prompted to enter specific information about the packages to be loaded. This information includes the package dimensions (length, width and height) 50, the mass or weight of one package or the total mass or weight of a shipment 52, data about a pallet, and the number of packages or pallets to be shipped 54. An example shipment is shown in FIG. 5. This shipment consists of 12 packages or cartons 80. The length of one package is represented by line L_{P1}−L_{P2} 94. The width of a package is represented by line W₁-W₂ 84. The height of one package is represented by line H_{P}-H₂ 90. Each package also has a certain mass value and weight value, one or both of which would be measured and entered into the present invention.

Returning to FIG. 4, information about the packages is entered in to the system: dimensions (length, width, height) 50, mass and/or weight 52, the number of packages 54, and whether the packages can be stacked 56. As indicated above, the program may assume that the packages can be stacked and the user can indicate otherwise. The user can select whether standard 58 or metric 60 units of measurement are used, or whether both could be used. A shipment which is travelling only in the United States will probably only need to be measured in standard units. A shipment that will only be travelling in Canada will likely only use metric units. However, a shipment might be travelling via truck, train, air or other means in both the U.S. and Canada and/or Mexico. For these shipments carriers and shippers would likely want the data in both standard and metric units for easy reference in all countries.

The system, method and computer program product of the present invention takes this package data and determines several pieces of information 62,64. This includes optimum width which is the optimum use of either length as width or width as width when packages are loaded in relation to the unit width. Other information determined is the number of packages per row in the unit, the weight of a row of packages, the cube of a row of packages, the length of a row of packages, the partial row width remaining, the partial row height remaining, the partial row length remaining, number of packages in a partial row or the number of more packages that could be used to fill a presently partial row, the partial row cube and the partial row weight. Each of these properties is illustrated in FIG. 5.

In FIG. 5, there is shown a shipment of twelve (12) packages 80. As described above, the length, width and height of a single package has been determined. In terms of the area/space calculator, the optimum width is a determination of whether the package dimensions labeled “length” should be interchanged with the package dimension labeled “width” to maximize space utilization. This deals with the orientation of the packages that would optimize space usage. For example, using dimensions of 48 in×40 in of a package in a unit that is 96 in wide, the optimum width to use would be the dimension 48 in because a width of 40 in would leave sixteen inches of open space in a unit that is 96 inches wide when two packages are loaded next to each other. Furthermore if left as 48 inches long, the package would use eight inches additional in the length of the unit, when it did not need to do so. This would amount to wasted space.

In addition to this, some shippers and/or receivers may choose to accept palletized shipments loaded in the configuration of the 48 inch dimension as length because they are shipped using hand pallet jacks. Pallet jacks are hand operated jacks which are used to move pallets. In these cases, the shipment may additionally be specified as unable to be double stacked. The shipment then takes up not only twice the equipment space but also the difference between the 40 and 48 inch lengths. The carrier must then utilize additional equipment or trips to make the run, since other customers' freight which would normally be included on these trips cannot be included. In consideration of this, in a preferred embodiment of the present invention, an override option is available for these situations, to account for the shippers/receiver's specifications.

Turning back to the shipment shown in FIG. 5, the number of packages per row in this example is five. This is determined by the area/space calculator based on the dimensions of a single package. The weight of a full row would be the total weight of the 5 packages in that row. The row cube would be the area occupied by the row. This would be calculated by multiplying the total length of all 5 packages in the row, represented by line L₁-L₂ 88 times the height of the packages represented by line H_{P}-H₂ 90 times the width of the row, represented by line W₁-W₂ 84. It should be understood that depending on the orientation of the shipment in FIG. 5 in the unit, the dimension represented by line L₁-L₂ 88 could be considered the width of the shipment while the dimension represented by W₁-W₂ 84 would be considered the length of the shipment. For ease of explanation, L₁-L₂ 88 will continue to be referred to as the width, but it should be understood that these dimensions can be interchanged depending on the orientation determined to be the best utilization of space in the area space calculator.

The row length L₁-L₂ 88 is the total length of all of the packages in the row. The partial row width left would be the width of area 96. The partial row height left could be one of two values. This dimension is saved by the system or program of the present invention for both of these possible values. The partial row height could be the height of area 96 represented by H_{P}-H₂ 90. Alternatively, the partial row height could be the distance left from the top of the last full row to the maximum height available in the unit, if this is different than the height of area 96. The partial row length is the length of the partial row represented by L₁-L_{P}. The partial row cube is the actual cube of the partial row 92 determined by the package dimensions and package cube for that row. This may also be referred to as the partial row filled. The cube remaining is the portion of the unit cube that is remaining to be utilized by additional packages. This could include cube over the top of the last partial row (area 96). The computation is always predicated on the usable loading area limited by the length of package/row times the width of unit times the loadable height of the full row/rows plus the partial row cube. The partial row weight or mass would be the weight of the packages in the partial row 92.

In instances where a longer package projects beyond some other packages, the longest length dimension is used to determine row length in a preferred embodiment of the present invention. There are also occasions where a top row may be utilized which does not fill the width to accommodate the optimum weight limit for that length of a row. In these cases, the area space calculator feature uses a “weight per lineal unit calculator”. This calculation uses the package length times the weight per inch which is determined to be optimal for this shipment. For instance, a user may have packages that are 12 in long at a weight limit per row of 972 lbs allowed for that row. If 64 packages fit in that row, weight can be limited to 972 lbs divided by 64 packages, which means that each package can be 15.1875 lbs. However, the program can calculate that if the packages each weigh 16 lbs, then only 56 packages will fit in a row. Alternatively, the number of packages in the top row of the shipment can be reduced to allow for the heavier packages. For instance, using only 4 packages in a top row instead of 8 packages might lessen the weight to come in under the weight limit.

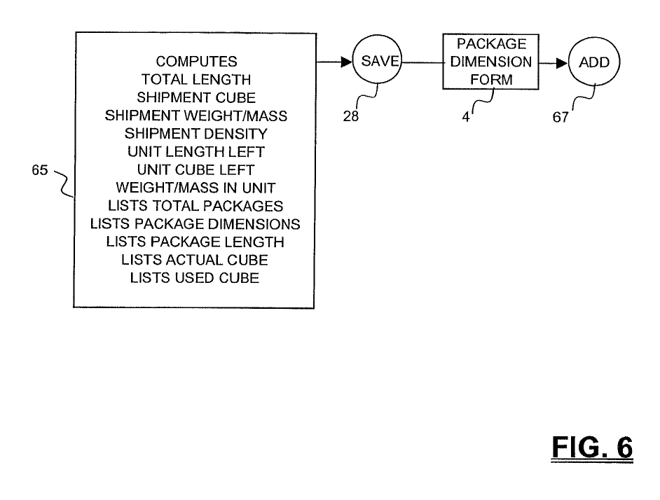

Turning now to FIG. 6, there are illustrated other calculation results that will be determined by the present invention. Once the process in FIG. 2 is completed for a first shipment and the user saves 28 the results, the user can enter data for more packages 24. At the end of the entry of each set of new packages, the program computes the results shown in FIG. 6 at 65. These are the total length of the total shipment, the cube of the total shipment, the total shipment weight or mass, the total shipment density, the length left in the unit, the cube left in the unit, the total additional weight which can be loaded in the unit, the total number of packages, the dimensions of each package or set of packages, the total length of the packages, and the cube used in the unit. These values can be in either metric or standard units. The user saves 28 these results and then can go to the package dimension form 4 to add 67 more packages and continue with the process shown in FIGS. 2-4.

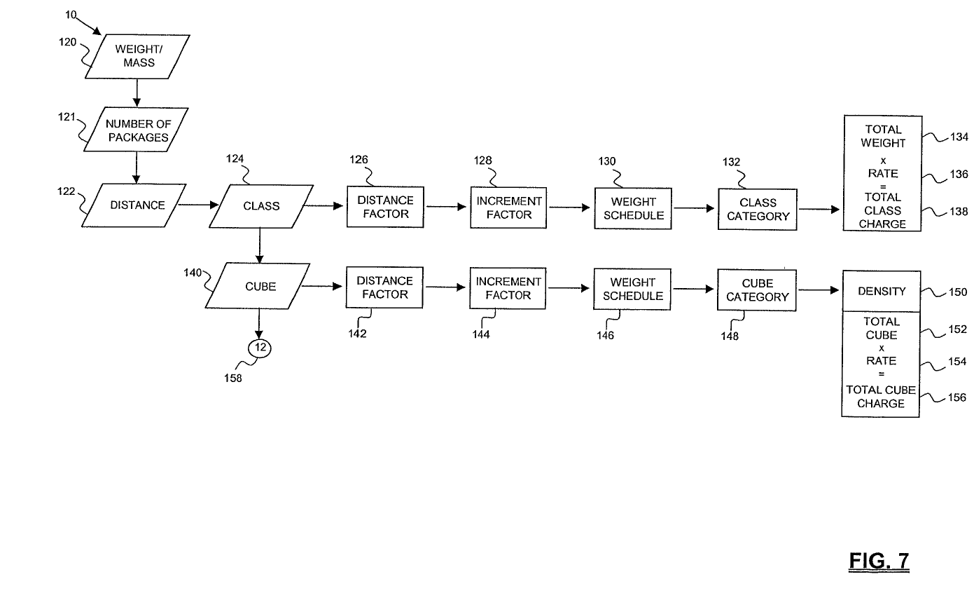

Turning now to FIG. 7, there is presented a flow chart which illustrates the pricing and costing system, method and computer program product of the present invention, generally designated 10. The process requires that certain information about the packages be collected and inputted into the program for use in the calculations. The information may be inputted only in to this portion of the invention or may be used from the area space calculator.

In the pricing and costing system, to determine the total class charges the process begins with entering package weight and/or mass 120 is entered. For example, a total weight or mass of 825 lbs or 374.21 kg is entered. Alternatively, a single package weight and the number of packages 121 can be entered. As indicated above, one of these measurements could be entered and the present system, method and computer program product could calculate the other measurements. Next, the distance 122 from point the point of origin to the destination, which the carrier must travel with the package is entered. For example, the distance 122 could be 1234 miles. The “class” 124, if known is entered next. Class 124 is an industry standard value, which classifies packages based on characteristics of the package such as dimensions, weight, density, type of contents, ease of handling, whether the contents are perishable or hazardous or other features of the package contents. Classes are defined by density ranges within this data, for instance, packages with a density between 8-10 lbs/foot³ will be in class 100. If the weight and/or class is not known, a “cube” 140 may alternatively be used in the pricing and costing system. For example, a shipment with dimensions of 4 ft×6 ft×4 ft would have a cube of 96 ft³. If this shipment weighed the 825 lbs mentioned above, the density would be 8.59 lbs/ft³ which would also make this shipment a Category 6 shipment. FIG. 8 shows a subroutine which may flow off of the chart in FIG. 7 to calculate the cube and density.

Table 1 shows the categories and the corresponding classes and density groups.

TABLE I
CATEGORY/CLASS/DENSITY

| | | DENSITY GROUP |
|---|---|---|
| CATEGORY | CLASS | (LBS/FT³) |
| 0 | 500 | |
| 1 | 400 | <1 |
| 2 | 300 | 1 < 2 |
| 3 | 250 | 2 < 4 |
| 4 | 150 | 4 < 6 |
| 5 | 125 | 6 < 8 |
| 6 | 100 | 8 < 10 |
| 7 | 92.5 | 10 < 12 |
| 8 | 85 | 12 < 15 |
| 9 | 70 | 15 < 25 |
| 10 | 65 | 25 < 35 |
| 11 | 60 | 35 < 45 |
| 12 | 55 | 45 < 55 |
| 13 | 50 | 55 < 100 |
| 14 | 25 | 100 > 100 |
| 15 | 200 | |
| 16 | 175 | |
| 17 | 110 | |
| 18 | 77.5 | |

Some of the categories or classes do not have a corresponding density value associated with them because they correspond to a density value which is specified in another class. If these classes are entered, the present system, method and computer program product will classify it in the category which corresponds to the appropriate density range.

Once this information is entered, the present invention continues with similar processes for the calculation of class and cube charges using a series of predetermined factors.

The next portion on the flow chart is the distance factor 126,142. In a preferred embodiment of the present invention, distance is segregated into five (5) different zones, namely distances of less than 350 miles, 350 miles to less than 1000 miles, 1000 to less than 2000 miles, 2000 miles to less than 3000 miles and 3000 miles or greater. These distances can be converted to other units of measurement such as kilometers or alternatively different distance categories may be used. Shipments are placed into a distance category based upon the actual number of miles that the shipment is to travel. A shipment which would be traveling a distance of 1234 miles would be in the 1000 to less than 2000 mile group. A distance factor 126, 142 is equal to the total of the integer number of miles divided by 50 minus 1 minus a normalization factor e.g. cint[(1234 miles/50 miles)−1]−20. The present program uses an application called cINTEGER which rounds the calculated value up to the nearest integer. Further, a normalization factor is also included in the calculation. This is a specific increment of distance which is charged for by the carrier and provides a differential increase for increments of distance between the distance groups. In a preferred embodiment, the increments are 50 miles each. The normalization factor is the number of increments in the lowest mileage amount in the distance group. Thus, the normalization factor for the 350 miles to less than 1000 miles group using 50 mile increments is 7 because 7 times 50 is 350. The normalization factor is subtracted from the distance factor to normalize the value due to the base rate being predicated on a 350 mile minimum. Thus, if the shipment is traveling 1234 miles, the distance factor is cint[1234 miles/50]=25−1=24 (for an effective mileage basis of (24×50) 1200—which is covered by the group range of 1200 to 1250 miles). The normalization factor is then subtracted from this to come up with a distance factor of 4. It should be understood that different categories for the distance can be used and that such distances can be measured in any type of units.

The normalization and distance factors for distance groups in miles in a preferred embodiment of the present invention are summarized in the following table.

TABLE 2
DISTANCE/INCREMENT FACTOR/BASE RATES

| | NORMALIZATION | |
|---|---|---|
| DISTANCE GROUP | FACTOR | DISTANCE FACTOR |
| <350 miles | | |
| 350-1000 miles | 7 | [(#miles/50)-1)-7 |
| >1000-2000 miles | 20 | [(#miles/50)-1)-20 |
| >2000-3000 miles | 40 | [(#miles/50)-1)-40 |
| >3000 miles | 60 | [(#miles/50)-1)-60 |

Other factors necessary for the calculation of charges are base rates to be charged for shipments. Each distance category has a base rate associated with it. The base rates are incremented for the various mileage groups. For each category, class and density group shown in Table 1, there is one base rate for each of the five distance groups. The base rates are determined by taking an actual shipment charge which is considered a fair rate in the industry. For example, a shipment that weighs 500 lbs and has a density of 8-10 lbs/ft³ would be in class 100. A fair charge to transport this shipment 1000 miles might be $630.00. To calculate the base rate in a preferred embodiment of the present invention, the weight of the shipment is divided by the lowest density amount in the class range. For a 500 lb shipment, this would be 500 lbs/8 lbs/ft³. The result of this calculation is 62.5 ft³, which is an estimate of the space that such a shipment would take in the carrier unit. Then, the fair or agreed upon charge amount is divided by the estimated cube which would be $630.00/62.5ft³=$10.08/ft³. This rate is divided by the distance that the shipment is to travel to get a rate per mile per cubic foot. Thus, $10.08/ft³/1000 miles is $0.01008/ft³/mile or 1.008 cents /mile. So a charge for taking a 62.5 ft³ shipment, 1000 miles would be 1.008 cents/ft³/mile×62.5 ft³ is 63.00 cents per mile. This rate could alternatively be expressed as 63.00$/mile/100 lbs. When used in the calculations, the distance units are dropped because the rates are assigned to a distance group.

The increment factor 128, 144 is a differential value for each segment of distance. The increment factor in a preferred embodiment of the present invention is in units of dollars (or other amount of money) per cubic unit of length per segment of distance. For instance, the amount could be 1.34 cents/ft³/50miles. This value is obtained by taking the base rate, for instance 63.00 cents per mile, and dividing that by an estimated cube for a shipment, for instance 62.5 ft³ which equals 1.01 cents/ft³/mile. In a preferred embodiment of the present invention, the increment value is used to increase the base rate for each 50 mile segment from the 350 mile minimum basis to the next mileage group. For instance, to go between the 350<1000 mile group and the 1000<2000 mile group the number of 50 mile increments between the lower limit of the first distance group and the lower limit of the second distance group would be calculated. There are thirteen 50 mile increments between 350 and 1000. Thus, the base rate would be increased from the 63.00 cents in the 350<1000 mile distance group to 76.13 cents/mile/ft³ in the 1000<2000 mile group because 13×1.01=13.13 cents plus 63.00 base rate 76.13 cents.

It should be understood that the present invention could be used to calculate any base rate or increment factor using any units of measurement or type of money. All that is needed is for a carrier and shippers to agree on a fair rate for certain types of shipments to be used in the calculation, the program will perform all of the necessary calculations.

Further, in a preferred embodiment of the present invention, the increment factors rates may be changed according to industry practices. For instance, in the industry, it is sometimes cheaper for a carrier to transport goods to the southern United States that to the east coast of the United States. Therefore different rates were given based on the destination of the shipment. In the present invention, rates for all areas of the country can be inputted and averaged to come up with an increment factor which will account for differences in rates for any destination.

It should also be understood that numbers calculated in this application, and numbers calculated using a computer program may vary slightly, due to the computer program retaining more decimal places.

Next, the program factors in a weight schedule 120, 146. The weight schedule is an industry standard which divides shipments into categories by weight. Shipments weighing less than 500 lbs, 500 to less than 1000 lbs, 1000 to less than 2000 lbs and so on are each a category schedule in the program. Each weight group is assigned a value to account for differences in the costs to the carrier based on the weight of the shipment. The prices and costs decrease as the weight group increases. But, it is less labor for a carrier to handle a shipment with fewer packages at the same weight. Thus, there is a reduction in the costs for various increasing weight groups. A sample weight schedule is shown below:

TABLE 3
WEIGHT SCHEDULE

| SCHEDULE | WEIGHT | VALUE |
|---|---|---|
| 0 | <500 lbs | |
| 1 | 500 < 1000 lbs | 0.80088 |
| 2 | 1000 < 2000 lbs | 0.67142 |
| 3 | 2000 < 5000 lbs | 0.5805 |
| 4 | 5000 < 10,000 lbs | 0.51058 |
| 5 | 10,000 < 20,000 lbs | 0.4312 |
| 6 | 20,000 < 30,000 lbs | 0.37805 |
| 7 | 30,000 < 40,000 lbs | 0.32838 |
| 8 | >40,000 lbs | 0.3081 |

Therefore, the shipment in the example which weighs 825 lbs is Schedule 2, which is 500 to less than 1000 lbs. The values in the weight schedule are percentage reductions of the base rate for a specific distance group. For instance, a shipment at a base rate of 63.00 cents for 1234 miles that weights 825 lbs is in the group of 500<1000 lbs and is reduced by multiplying 63.00 times 0.80088. These reductions are based upon the shipping/hauling industry standards.

For example, as a shipment of product that is stated to be class 100 would be in Category 6, at the same time, a product having a density of 8 to 10 lbs/ft³ would be in Category 6. Charges for both would effectively be the same, provided that the Area Space Calculator showed that they both occupied the same parameters. Further, a shipment of a class 100 at a weight of 500 lbs should occupy a total of between 50 to 62.5 ft³. But, should the package be pyramid shaped, no other freight could be loaded on top of it. This changes the cube occupied to incorporate the wasted space. Now, the package would occupy a total of over 100 cubic feet, because of the wasted top space. This in effect, changes the density parameters to be in the 4-6 lbs/ft range which is in Category 4 (which is effectively a class 150). This package now has a higher price and cost basis which the program recognizes and the charges would be assessed on the higher basis. The Class and Cube are used as cross checks, because the costs are different based on the space occupied.

To show an example calculation, a total shipment weight of 825 lbs, falls into the weight category of greater than 500 but less than 1000 pounds and is in Schedule 2, the value for the weight schedule at that weight is 0.80088. The shipment is to be transported 1234 miles and is thus in the distance group of 1000<2000 miles and the base rate is 76.11$/100 lbs. An increment factor for this distance group which account for variations in nationwide shipping charges may be $1.34.

The calculation for this situations is shown as the following example:

### EXAMPLE 1

TOTAL SHIPMENT WEIGHT=825 lbs

DIMENSIONS=4 ft×6 ft×4 ft

DISTANCE=1234 miles

BASE RATE=$63.00/100 lbs

INCREMENT FACTOR=1.34

CATEGORY=6

DENSITY GROUP=8-10 lbs/ft³

Rate=Base rate+(Increment Factor×Number of increments)

Rate=$63.00/100 lbs+(1.01×13)

Rate=$76.13/100 lbs

X=Charges=1×({{([cint(Distance Factor)×Increment Factor}+base rate value}×weight schedule value)×total shipment weight.

X = 1 × ({{([cint(1234miles/50miles)-1]-20) × 1.01} + 76.13$/
100 lbs} × 0.80088) × 825 lbs
X = ({{([25-1]-20) × 1.01} + 76.13$/100lbs} × 0.80088) × 825 lbs
X = ({4 × 1.01} + 76.13$/100lbs} × 0.80088) × 825 lbs
X = ({4.04 + 76.13$/100 lbs} × 0.80088) × 825 lbs
X = (80.17$/100lbs × 0.80088) × 825 lbs
X = 64.201$/100 lbs × 825 lbs
X = 52970$/100
X = 529.70$

The above described process computes a total charge 138, 156 for the particular shipment. The numeral 1 that is multiplied by the entire charge calculation represents a factor that can be used for rate increases or discounts. For instance, if a carrier wants to increase rates by 5% it can put the factor 1.05 into the calculation above to include that increase in the calculation.

Based on the calculated rate, the total charge for a class 138 or the total charge for a cube 156 is computed. The total class charge is calculated by multiplying the total weight of the shipment 134, by the rate 136 for that shipment. The total cube charge 156 calculation is based on the density of the package. In this calculation, the density 150 of the shipment is determined as well because the area of the package is known. In this case, density will be in units such as lbs/in³, using the weight that was entered at the beginning of the process. Once the cube is determined, the shipment is assigned a category and the rates and the increment value are determined. Then the calculation proceeds as described for the class charges.

FIG. 8 illustrates the process of calculating a cube for the rate calculation as described above. If the cube 140 is not known, the program calls up a subroutine, generally designated 12, to calculate the cube. This subroutine could be used in the area space calculator as well. FIG. 8 shows the cube as being calculated in standard units and metric units and conversions between the two systems of measurement. The user can enter package dimensions in standard units 186 such as inches or feet or the package dimensions may be entered in metric units 196 such as meters or centimeters. Alternatively, the dimensions can be entered in one of these units and be converted to the other as indicated by the arrow joining 186 and 196. For both units of measurement, the next step is to enter the number of pieces 188 or 198. If a single package is being shipped, the number of pieces is “1”. This piece of data is important when multiple packages are being sent because this function will calculate the total area or “cube” that all of these packages will occupy. In the example of Shipper D's packages, 2 pieces would be entered at 188 or 198. Next, the subroutine calculates the standard cube 190 or the metric cube 200. Either of these calculated cube calculations will then be used at 140 in flowchart 10 in FIG. 7.

The subroutine in FIG. 8 can also be used to determine the density of the shipment. If the cube calculation is being performed independently of the pricing and costing system 10, the density calculation can be performed by entering the standard package weight 192 or the package mass 202. These will combine with the cube calculated at 190, 200 to compute the density of the package or shipment 194, 204. In standard units, the density would be in pounds per cubic foot or cubic inches. In metric units the density would be in grams or kilograms per cubic meter or cubic centimeters. This densities can also be converted from metric to standard and vice versa. The program can also plug the densities into the pricing and costing system 10 to determine the rate.

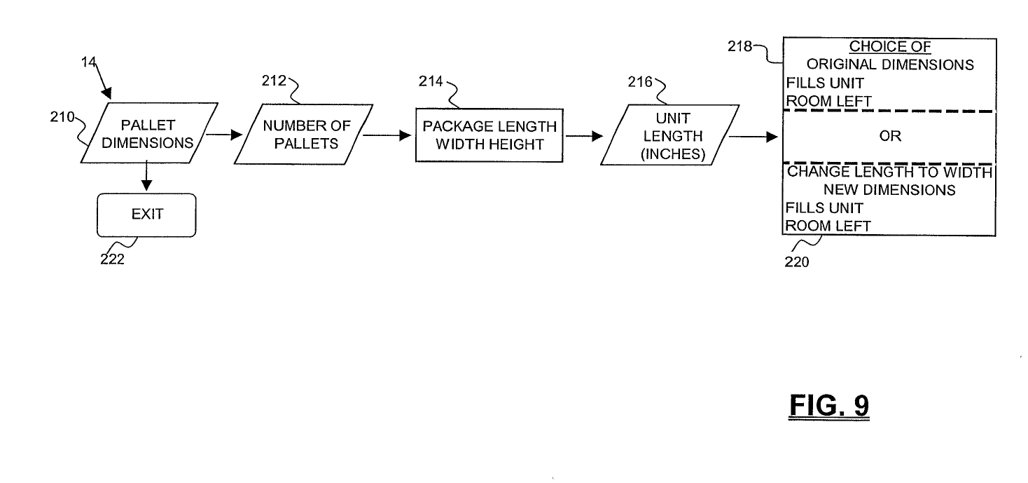

FIG. 9 illustrates a cube calculation for packages being shipped on pallets, generally designated 14. As shown in the drawing, if a pallet is not being used, the user can choose to exit 222 to proceed with other portions of the program. If pallets are being used, the user will proceed to use this form. First, the dimensions of the pallet 210 are entered. These dimensions include all of the packages loaded onto the pallet. The “extreme dimension” are used. This means that if the packages on the pallet are not on flat level, for instance if one package is stacked on top of the top of a full row of packages, the pallet will be treated as having an additional height level. The user will then enter the number of the pallets 212 and the pallet dimensions, length, width and height 214. In addition, the length of the unit 216 (truck, van etc) is entered. At the end of this process, the program will show the user the amount of space the shipment occupies and the room left in the truck/unit 218. The program will alter the orientation of the pallet to the most efficient utilization of space 220. For instance, the value used as the length of the pallet could be altered to represent the width 220 of the unit to occupy the fill width of the unit. For instance, with a 48 length pallet×40 width pallet in a unit with a width of 96, the best usage would be to use the 48 inch width instead of the 40 inch as width. The program will show the user which orientation is a more efficient way to load the pallet to maximize usage of space. This feature is also part of the area/space calculator portion of the present invention.

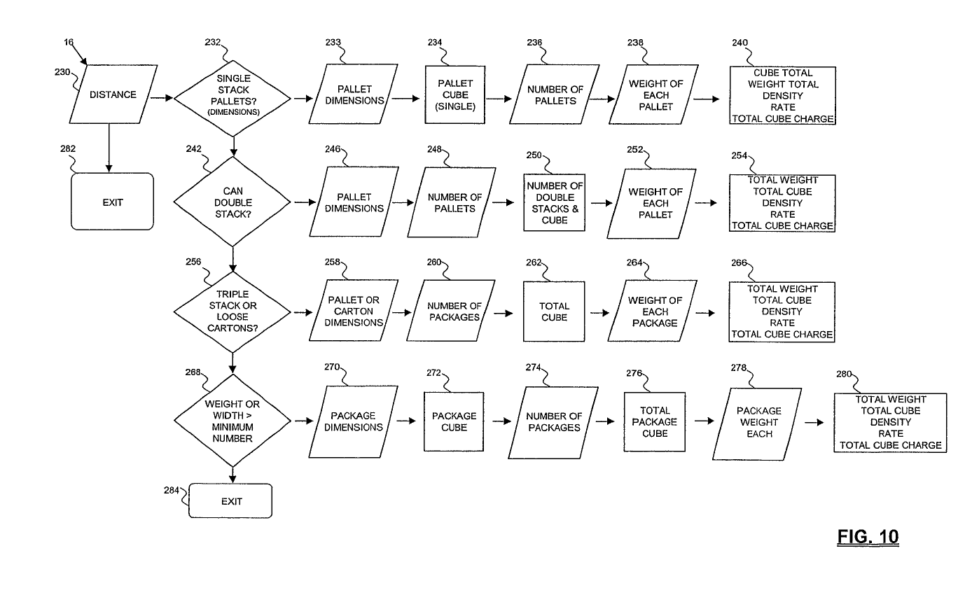

FIG. 10 illustrates an alternative method of determining rate based on the space utilization or actions by the shipper. The alternative method, also referred to as spot sizing or pricing is generally referred to as 16. In this portion of the invention, the distance from the point of origin to a destination is entered at 230. Then the user is prompted with a series of questions to determine how the packages will be loaded which affects the pricing system. The first piece of information is whether or not the pallets can be stacked on top of one another. If pallets cannot be stacked on top of one another, the pallet will be classified as a single stack 232. To determine the costs and price for the single stacked pallets, the user inputs the dimensions of the pallet 233. The program calculates the cube for that pallet 234. Then the number of pallets 236 is entered and the weight of each pallet 238. Then all of this data goes through the pricing and costing system at 10. The output of this process is the total cube for this pallet, the total weight for the pallet, the density of the pallet, the rate and the total charge for the pallet cube 240.

If the pallets can be double stacked 242, the user proceeds to enter the dimensions of the pallets 246, the number of pallets 248 and the weight of each pallet 250. The program will calculate the number of double stacks and cube 252 that are within the unit's capacity. Finally, the data will be used in the pricing and costing system 10 resulting in a calculation of the total weight, the total cube, the density, rate and total cube charge for the double stacked pallets 254.

The pallets may also be able to be triple stacked or the shipper may be shipping loose cartons or packages 256. In this case, the user will enter pallet or carton dimensions 258, the number of packages or pallets and the weight of each package or pallet 262. The program will compute the total cube for these pallets or packages 264. Finally, after the computations of pricing and costing 10 are completed the output of total weight, total cube, density, rate and total cube charge 266 are displayed.

Finally, some packages may have a height that is greater that some predefined minimum amount 268. These packages are unable to be double or triple stacked because their height does not allow it. In these cases, the shipper is usually charged as if it is taking up all of the room in the unit. In this situation, the user will enter the package dimensions 270. The program will then calculate the package cube 272. The user further enters the number of packages 274 and the program can determine the total package cube. The user also enters the weight of each package 278 so that the program can calculate the total weight. Finally, after proceeding with the pricing and costing system 10, the total weight, total cube, density, rate and total cube charge 280 are determined.

The user can choose to exit 282, 284 if none of the options are applicable to a particular shipment.

As an alternative way to calculate charges, a preferred embodiment of the present invention may include a feature which calculates the charges for a shipment based only on the physical properties of the shipment, the distance to be traveled and an agreed upon rate. This feature is referred to as a “set-rate calculator”. This feature uses a desired rate per mile basis. This feature takes data from the area space calculator and produces comparative rates for different cubic foot measurements, unit length available, class charges or weight charges and whether or not pallets or racks are used. All of the charges in this feature are relative to the overall capacity of the unit to the proportion occupied by a particular shipment.

For instance, cube charges are the relationship of the cube to the capacity of the unit. This is tied to a specific amount that either the carrier wants to charge for the service or is willing to offer the shippers. For example, if a shipment is 1000 cubic feet and weighs 1000 lbs and is being transported a distance of 1000 miles. The carrier and shipper may agree on a rate of $4.00 per mile.

In the set-rate pricing and costing system, to determine the charges the process begins with entering the agreed upon rate per mile and then importing or copying or entering data from the area space calculator such as the cube of the shipment, the overall density of the shipment, the length of space the shipment occupies, the distance, the class, the total weight and/or whether or not racks are required.

Formulas are used in the present invention to calculate charges based on the various results provided by the area space calculator.

In this embodiment of the present invention, the area space calculator is used to determine the capacity of the carrier unit, the cube of the shipment, the density of the shipment, the total weight of the shipment the total length of the shipment. The user can either enter the class of the shipment or the program can determine the class based on the density of the shipment. The processes for performing all of these calculations are described above. In contrast to the embodiment of the invention described above, the set-rate application does not use the weight schedules or distance groups.

For cube charges, the program calculates whether the density capacity of the unit exceeds the density of the shipment. The density capacity of the unit is calculated by dividing the total weight that the unit can accommodate by the total cube of the unit.

The following example illustrates the various calculations that can be performed using the set rate. In all of the formulas shown, the “cdec” factor holds the result of the calculation to seven decimal places.

### EXAMPLE 2

A truck may have a capacity of 3008 ft³ and be able to accommodate a total weight of 46000 lbs. In this example, the shipment is 12.28 ft long, has a cube of 1031.25 ft³, weighs a total of 8250 lbs and has a density of 8 lbs/ft³. The shipment is being transported a distance of 1234 miles and the agreed upon rate per mile is $1.00.

If this is the case, the total cube charges are calculated using the following formula (cube charge=x):

X= Cubic Charge = cdec((rate per mile/cint(unit density capacity)) / (unit cube x

cint(unit density capacity)/ shipment density) x distance x shipment density x shipment

cube

X= cdec(($1.00/milecint(46000lbs/3008ft³))/3008ft³) x (cint(46000lbs/3008ft³) / 8lbs/ft³))

x 1234miles x 8lbs/ft³ x 1031.25ft³

X=cdec(($1.00/mile/15lbs/ft³)/3008ft³) x (15lbs/ft³/8lbs/ft³) x 1234miles x 8lbs/ft³ x

1031.25ft³

X=cdec($0.0666666/mile/lbs/ft³/3008ft³) x 1.875 x 1234miles x 8lbs/ft³ x 1031.25ft³

X=cdec($0.0000221/mile/lbs) x 1.875 x 1234 miles x 8lbs/ft³ x 1031.25ft³

X=$421.47

Charges based on the length of the shipment are calculated using the following formula (length charges=x):

X = Length Charges = cdec (rate per mile / unit length ) x (unit length / actual

unit length) x distance x shipment length

X = cdec(($1.00/mile)/47.25ft) x (47.25ft/47.25ft) x 1234miles x 12.28ft

X = cdec$0.021164/mile-ft x 1 x 1234mile x 12.28ft

X = $320.71

The class charges are computed as follows (class charge=x):

Class Charge = x = cdec((rate per mile/ unit density) / unit cube) x (unit density /

shipment density) x distance x class density x shipment cube

X = cdec(($1.00/mile/cint(46000lbs/3008ft³)/3008ft³) x

[cint(46000lbs/3008ft³)/8lbs/ft³] x 1234miles x 8lbs/ft³ x 1031.25ft³

x = cdec($0.0666666/mile-lb/ft³/3008ft³) x 1.875 x 1234miles x 8lbs/ft³ x

1031.25ft³

x = cdec$0.0000221/mile-lbs x 1.875 x 1234miles x 8lbs/ft³ x 1031.25ft³

x = cdec$421.47

For weight charges, the following computation is used (weight charge=x):

Weight Charge = x = cdec(rate per mile / (shipment density x unit cube)) x weight

x distance

X = cdec($1.00/mile/(8 lbs/ft³ x 3008ft³) x 8250lbs x 1234miles

X=cdec($1.00/mile/24064lbs) x 8250lbs x 1234miles

x = cdec($0.0000415/mile-lbs) x 8250lbs x 1234miles

x = cdec $422.49

It should be understood that the dollar values shown here may be slightly different when computed with a hand held calculator than with a other computer products as some of the decimal places may be dropped in the calculator. When determining which of these charge bases to use, the carrier may use various methods to choose which charge to use. The carrier may want to choose the highest charge, the lowest charge, the average charge, or the mean charge. Any of the charge amounts would be understood to be a valid basis for charging a shipper for transporting a shipment of goods.

The foregoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention as defined in the claims. Within the claims, means-plus-function language is intended to cover the structures described in the present application as performing the recited function, and not only structural equivalents but also equivalent structures. The written description and drawings illustrate the present invention and are not to be construed as limited to the specific embodiments disclosed. Modifications to the disclosed embodiments, as well as other embodiments, are included within the scope of the claims. The present invention is defined by the following claims, including equivalents thereof.

What is claimed is:

1. A computerized method for calculating charges for transporting a shipment of freight, said shipment comprising one or more packages, said method comprising the steps of:
gathering physical property data about a carrier unit, said data comprising carrier unit dimensions and weight limit of said carrier unit;
determining a total available capacity in said carrier unit, wherein said total available capacity comprises a weight limit for said carrier unit and a volume of said carrier unit;
storing said total available capacity in said carrier unit;
gathering a distance a first shipment is to be transported;
gathering physical property data about said first shipment, wherein said physical property data is selected from the group consisting of dimensions of one package in said shipment, volume of one package in said shipment, weight of one package in said shipment, mass of one package in said shipment, dimensions of said shipment, weight of said shipment, volume of said shipment, mass of said shipment, number of packages in said shipment, density of said shipment, class of said shipment;
determining an amount of said total available capacity to be occupied by said first shipment in said carrier unit, wherein said amount of total available capacity to be occupied by said first shipment comprises a total weight of said first shipment and a total volume to be occupied by said first shipment;
storing said amount of said total available capacity occupied by said first shipment in said carrier unit;
determining remaining available capacity in said carrier unit after said first shipment is loaded in said carrier unit;
storing said remaining available capacity in said carrier unit; and
determining a rate to be charged for said first shipment based upon said amount of said total available capacity occupied by said first shipment in said carrier unit and said distance said first shipment is to be transported;
storing said rate;
calculating a total charge for transporting said first shipment; and
displaying said total charge.

2. The method as recited in claim 1, further comprising:
determining an optimal orientation of said first shipment relative to said carrier unit available capacity; and
storing said optimal orientation of said first shipment.

3. The method as recited in claim 1, further comprising:
gathering a distance a second shipment is to be transported;
gathering physical property data about said second shipment, wherein said physical property data is selected from the group consisting of dimensions of one package in said shipment, volume of one package in said shipment, weight of one package in said shipment, mass of one package in said shipment, dimensions of said shipment, weight of said shipment, volume of said shipment, mass of said shipment, number of packages in said shipment, density of said shipment, class of said shipment;
determining an amount of said total available capacity to be occupied by said second shipment in said carrier unit, wherein said amount of total available capacity to be occupied by said second shipment comprises a total weight of said second shipment and a total volume to be occupied by said second shipment;
storing said amount of said total available capacity occupied by said second shipment in said carrier unit;
determining remaining available capacity in said carrier unit after said second shipment is loaded in said carrier unit;
storing said remaining capacity in said carrier unit;
determining a rate to be charged for said second shipment based upon said amount of said total available capacity occupied by said second shipment in said carrier unit and said distance said second shipment is to be transported;
storing said rate;
calculating a total charge for transporting said second shipment; and
displaying said total charge.

4. The method as recited in claim 3, further comprising:
determining the optimal orientation of said second shipment relative to said carrier unit and relative to said first shipment; and
storing said optimal orientation of said second shipment.

5. The method as recited in claim 4, further comprising:
determining the optimal orientation of said first shipment relative to said carrier unit and said second shipment using said stored optimal orientation of said first shipment.

6. The method as recited in claim 1, wherein said step of determining a rate to be charged for said shipment comprises:
determining a fair price for transporting a shipment having substantially similar physical properties to said first shipment.

7. The method as recited in claim 1, wherein said step of calculating a total charge for transporting said first shipment comprises:
determining a total density capacity of said carrier unit by dividing said weight limit of said carrier unit by said volume of said carrier unit;
determining a volume of said first shipment;
determining a density of said first shipment;
computing a first cube charge calculation value by dividing said rate by said total density capacity;
computing a second cube charge calculation value by dividing the product of the volume of said carrier unit multiplied by the total density capacity of said carrier unit by a density of said first shipment;
calculating a third cube charge computation value by dividing said first cube charge computation value by said second cube charge computation value; and
multiplying said third cube charge computation value by a number of miles said first shipment is to be transported, the density of said first shipment and the volume of said first shipment.

8. The method as recited in claim 1 wherein said step of calculating a total charge for transporting said first shipment comprises:
determining a total length of said first shipment;
determining a total length of said carrier unit;
dividing said rate by said length of said carrier unit; and
multiplying the product of said rate divided by said total length of said carrier unit by said distance said first shipment is to be transported and a length of said first shipment.

9. The method as recited in claim 1 wherein said step of calculating a total charge for transporting said first shipment comprises:
determining a volume of said shipment;
determining a density of said first shipment;
determining a density class of said shipment;
determining a total density capacity of said carrier unit by dividing the weight limit of said carrier unit by the volume of said carrier unit;
computing a first class charge calculation value by dividing the product of the rate divided by said total density capacity of said carrier unit by said volume of said carrier unit;
computing a second class charge calculation value by dividing the total density capacity of said carrier unit by said density of said first shipment; and
multiplying said first class charge calculation value, said second class charge computation value, said distance said first shipment is to be transported, said class density value and said volume of said shipment.

10. The method as recited in claim 1, wherein said step of calculating a total charge for transporting said first shipment comprises:
determining a total weight of said first shipment;
determining a total volume of said first shipment;
determining a density of said first shipment;
dividing said rate by the product of said shipment density multiplied by the shipment volume to calculate a weight charge value; and
multiplying said weight charge value by said total weight of said first shipment and said distance said first shipment will be transported.

11. A data processing system for calculating charges for transporting a shipment of freight, said shipment comprising one or more packages, said method comprising the steps of:
a computing device and a display;
means for entering information about a carrier unit said information comprising one or more members of the group consisting of dimensions of said carrier unit, weight capacity of said carrier unit, density capacity of said carrier unit; and length of said carrier unit;
means for calculating a total volume and a weight capacity of said carrier unit based on said entered information about said carrier unit;
means for storing said total volume and said weight capacity of said carrier unit; means for displaying said total volume and said weight capacity of said carrier unit;
means for entering a distance a first shipment is to be transported;
means for entering information about said first shipment, said information comprising one or more members of the following: dimensions of one package in said shipment, volume of one package in said shipment, weight of one package in said shipment, mass of one package in said shipment, dimensions of said shipment; volume of said shipment, weight of said shipment, mass of said shipment, density of said shipment, number of packages in said shipment; and class of said shipment;
means for determining a value for said first shipment of a volume of said first shipment, a density of said first shipment, a total weight of said first shipment, and a total length of said first shipment based on said information entered about said first shipment;
means for storing said values of said volume of said first shipment, said density of said first shipment, said total weight of said first shipment, and said total length of said first shipment based on said information entered about said first shipment;
means for displaying said calculated values for said first shipment;
means for determining the optimal orientation of one or more packages in said first shipment relative to said carrier unit;
means for storing said optimal orientation of said one or more packages in said first shipment;
means for displaying said optimal orientation of said one or more packages in said first shipment;
means for determining an amount of carrier unit total area occupied by said first shipment and a portion of weight capacity occupied by said first shipment;
means for storing said amount of carrier unit area occupied by said first shipment and said portion of weight capacity occupied by said first shipment; and
means for displaying said amount of carrier unit area and said portion of weight capacity occupied by said first shipment.

12. The data processing system as recited in claim 11 further comprising:
means for entering a distance said second shipment is to be transported;
means for entering information about a second shipment, said information comprising at least one member of the following: dimensions of one package in said shipment, volume of one package in said shipment, weight of one package in said shipment, mass of one package in said shipment, dimensions of said shipment; volume of said shipment, weight of said shipment, mass of said shipment, density of said shipment, number of packages in said shipment and class of said shipment;
means for calculating values for a volume of said second shipment, a density of said second shipment, a total weight of said second shipment, and a total length of said second shipment;
means for storing said values of said volume of said second shipment, said density of said second shipment, said total weight of said second shipment, and said total length of said second shipment;
means for displaying said values for said second shipment;
means for determining the optimal orientation of one or more packages in said second shipment relative to said carrier unit and relative to said first shipment;
means for storing said optimal orientation of said one or more packages in said second shipment;
means for displaying said optimal orientation of said one or more packages in said second shipment;
means for determining an amount of carrier unit total area occupied by said second shipment and a portion of weight capacity occupied by said second shipment; and
means for storing said amount of carrier unit area occupied by said second shipment and said portion of weight capacity occupied by said second shipment; and means for displaying said amount of carrier unit area and said portion of weight capacity occupied by said second shipment.

13. The data processing system as recited in claim 11, further comprising:
means for calculating charges for transporting said first shipment.

14. The data processing system as recited in claim 13 wherein said means for calculating said charges for transporting said first shipment comprises:
means for entering a rate to be charged based on said distance said first shipment is to be transported and at least one physical property of said shipment;
application for recalling at least one member of the following group: total volume occupied by said first shipment, total weight of said first shipment, total length of said first shipment or class of said first shipment; and
application for recalling said total available capacity of said carrier unit;
application for recalling said distance that said first shipment is to be transported; and
application for calculating charges for transporting said shipment relative to said total capacity of said carrier unit based on said distance and at least one member of the following: total volume occupied by said shipment, total weight of said shipment, total length of said shipment and class of said shipment.

15. A computer program product for use with a data processing system for calculating charges for transporting a shipment of freight, said shipment comprising one or more packages, said method comprising the steps of:
a computer usable medium having computer readable program code means embodied in said medium for determining available capacity in a carrier unit;
the computer usable medium having computer readable program code means embodied in said medium for determining an amount of space to be occupied by a first shipment in said carrier unit;
the computer usable medium having computer readable program code means embodied in said medium for determining remaining capacity in said carrier unit after said first shipment is loaded onto said carrier unit;
the computer usable medium having computer readable program code means embodied in said medium for determining an optimal orientation for said first shipment in said carrier unit;
the computer usable medium having computer readable program code means embodied in said medium for storing said available capacity of said carrier unit, said amount of space to be occupied by said first shipment in said carrier unit, said remaining space in said carrier unit after said first shipment is loaded into said carrier unit, and said optimal orientation of said first shipment in said carrier unit; and
the computer usable medium having computer readable program code means embodied in said medium for determining whether additional packages can be added to said carrier unit.

16. The computer program product as recited in claim 15 further comprising:
the computer usable medium having computer readable program code means embodied in said medium for determining an amount of space to be occupied by a second shipment in said carrier unit;
the computer usable medium having computer readable program code means embodied in said medium for determining remaining capacity in said carrier unit after said second shipment is loaded onto said carrier unit;
the computer usable medium having computer readable program code means embodied in said medium for determining an optimal orientation for said second shipment in said carrier unit relative to said first shipment;
the computer usable medium having computer readable program code means embodied in said medium for storing said amount of space to be occupied by said second shipment in said carrier unit, said remaining space in said carrier unit after said second shipment is loaded into said carrier unit, and said optimal orientation of second first shipment in said carrier unit; and
the computer usable medium having computer readable program code means embodied in said medium for determining whether additional packages can be added to said carrier unit.

17. The computer program product as recited in claim 15, further comprising:
a computer usable medium having computer readable program code means embodied in said medium for entering a rate to be charged based on said distance and at least one physical property of said first shipment;
the computer usable medium having computer readable program code means embodied in said medium for determining at least one member of the following group a total volume occupied by said first shipment, a total weight occupied by said first shipment, a total length of said first shipment or a class of said first shipment; and
the computer usable medium having computer readable program code means embodied in said medium for calculating charges for transporting said shipment relative to said total capacity of said carrier unit based on said distance and at least one member of the following: total volume occupied by said shipment, total weight of said shipment, total length of said shipment and class of said shipment.
